(19) United States
(12) Patent Application Publication
(10) Pub. No.: US 2011/0195217 A1
(43) Pub. Date: Aug. 11, 2011

(54) NOTE SHEET AND PADS THEREOF AND RELATED METHOD

(76) Inventors: Jay K. Sato, Mission Viejo, CA (US); Eric Kim, Irvine, CA (US); Susan L. Broyles, Sierra Madre, CA (US); Darren S. Ferris, La Habra Heights, CA (US); Cheng-Chung Chang, Kaohsiung (TW); Tsun-Rung Hsu, Kaohsiung (TW)

(21) Appl. No.: 12/829,386

(22) Filed: Jul. 2, 2010

Related U.S. Application Data
(63) Continuation-in-part of application No. 29/355,485, filed on Feb. 8, 2010.
Application No. 29/355,485 is a continuation-in-part of application No. 29/361,471, filed on May 11, 2010.

(51) Int. Cl. B32B 33/00; B32B 37/12; B32B 37/14; B32B 38/04; C09J 7/02; B65D 85/00; G09F 3/10

(52) U.S. Cl. 428/41.8; 156/250; 156/182; 156/252; 428/40.1; 206/215; 428/77; 428/43

(57) ABSTRACT

A note sheet is provided that includes a body portion and a tab portion integral with the body portion and extending from an end thereof. At a location where the tab portion and the body portion meet one another, at least one arced shoulder is formed therebetween. The note sheet is formed from a multilayer construction including a base layer extending substantially the entirety of the body and the tab portions. The base layer having a first surface and a second surface. The note sheet includes a first layer of adhesive on the second surface of the base layer that is located on the body portion of the note sheet, but not the tab portion.

### CROSS-REFERENCE TO RELATED APPLICATIONS

The present application is a continuation-in-part application of U.S. patent application Ser. No. 29/355,485, filed Feb. 8, 2010, entitled “Note Sheets and Related Pads of Note Sheets,” by Jay K. Sato, Eric Kim, Susan L. Broyles, Darren S. Ferris, Cheng-Chung Chang, and Tsun-Rung Hsu, and a continuation-in-part of U.S. patent application Ser. No. 29/361,471, filed May 11, 2010, entitled “Note Sheets and Related Pads of Note Sheets,” by Jay K. Sato, Eric Kim, Susan L. Broyles, Darren S. Ferris, Cheng-Chung Chang, and Tsun-Rung Hsu, both of which are incorporated herein by reference in their entirety.

### FIELD OF THE INVENTION

The present inventive subject matter relates generally to the art of adhesive backed note sheets. Particular relevance is found in connection with tab bearing note sheets, and accordingly the present specification makes specific reference thereto. However, it is to be appreciated that aspects of the present inventive subject matter are also equally amenable to other like applications.

### BACKGROUND

Adhesive note sheets are generally known. However, certain prior art adhesive note sheets can exhibit some drawbacks, e.g., such as lacking good writability, the tendency to become undesirably detached when used to lift or turn a page to which they are adhered, etc.

Accordingly, a new and/or improved adhesive-backed note sheets and/or pads thereof are disclosed, which address the above-referenced problem(s) and/or others.

### SUMMARY

In accordance with one exemplary embodiment, a note sheet is provided that includes a body portion and a tab portion integral with the body portion and extending from an end thereof. At a location where the tab portion and the body portion meet one another, at least one arced shoulder is formed therebetween. The note sheet if formed from a multilayer construction that includes a base layer and a first adhesive layer. The base layer extends a substantial entirety of the body and tab portions, and has a first surface and a second surface. The first layer of adhesive is on the second surface of the base layer and is located on the body portion of the note sheet, but not the tab portion.

In other, more detailed features of the invention, the multilayer construction further includes an overlay. The overlay is on the first surface of the base layer and is located on the tab portion of the note sheet, but not the body portion. Also, the overlay can be made of a paper material.

In other, more detailed features of the invention, the multilayer construction further includes a second layer of adhesive between the overlay and the base layer to secure the overlay to the base layer. The second layer of adhesive is located on the tab portion of the note sheet, but not the body portion.

In other, more detailed features of the invention, the multilayer construction further includes an ink receptive topcoat layer on the first surface of the base layer. Also, the multilayer construction can include a release coat layer on the ink receptive topcoat layer opposite the base layer. The release coat layer can be receptive to marking with indicia.

In other, more detailed features of the invention, the multilayer construction further includes a primer layer on the first surface of the base layer between the ink receptive topcoat layer and the base layer that aiding anchorage of the ink receptive topcoat layer to the base layer.

In other, more detailed features of the invention, the primer layer, ink receptive topcoat layer, and release layer are on the body portion of the note sheet, but not on the tab portion.

In other, more detailed features of the invention, wherein the primer layer, ink receptive topcoat layer, and release layer are on the body portion of the note sheet and the tab portion, the primer layer, ink receptive topcoat layer, and release layer are between the second layer of adhesive and the base layer on the tab portion of the note sheet. Also, the release layer and the second layer of the adhesive can be chosen so that overlay does not functionally release from the note sheet.

In other, more detailed features of the invention, the multilayer construction further includes a primer layer disposed on the second surface of the base layer between the first adhesive layer and the base layer. The primer layer aids anchorage of the first adhesive layer to the base layer.

In other, more detailed features of the invention, the base layer is a polyethylene terephthalate (PET) film. Also, the PET film can be tinted with a color.

In other, more detailed features of the invention, the first layer of adhesive cover substantially all of the body portion of the note sheet. Also, the first adhesive layer can be a pressure sensitive adhesive (PSA).

In other, more detailed features of the invention, the body portion of the note sheet is translucent. Also, the body portion can include at least one line of weakness that extends across the body portion. The line of weakness divides the body portion into distinct sub-sections. At least one sub-section is selectively removable from the note sheet by separating the sub-section from the body portion along the line of weakness.

In other, more detailed features of the invention, the note sheet can include a second tab portion extending from a second end of the body portion.

Another exemplary embodiment is a pad of note sheets. The pad of note sheets includes a plurality of notes sheets that are stacked such that an overlying note sheet is releasably adhered to an adjacent underlying note sheet via a first adhesive layer of the overlying note sheet.

In other, more detailed features of the invention, the pad of note sheets includes a bottom-most note sheet that is attached to a release liner via the first adhesive layer of the bottom-most note sheet. Also, the release liner has an outer periphery that substantially matches the outer periphery of the note sheets.

In other, more detailed features of the invention, the pad of note sheets includes a plurality of sheets having a second tab portion extending from a second end of the body portion and the first tab portion includes an overlay. The plurality of sheets are stacked such that the first tab portion of the overlying note sheet overlies the second tab portion of the adjacent underlying not sheet.

Another exemplary embodiment is a package of note sheets. The package has at least two pads.

In other, more detailed features of the invention, the at least two pads are joined together via adhesive tape.

In other, more detailed features of the invention, the at least two pads are adhered to a backing card.

An exemplary method according to the invention is a method for manufacturing a package of note sheets. The method includes providing a film, an overlay, and an adhesive. The film has a first side and a second side. The method also includes coating the second side of the film with the adhesive and laminating the overlay to the first side of the film to form a multilayer construction. The method also includes sheeting the multilayer construction into sheets with each sheet having an adhesive layer side and an overlay-bearing side. The method also includes stacking the sheets to form a stack of sheets in which the adhesive layer side of each sheet is in contact with the overlay-bearing side of an adjacent sheet, and the last sheet of the stack of sheets has an exposed adhesive layer side. The method also includes adhering the exposed adhesive layer side to a carrier sheet, and die cutting the stack of sheets and adhered carrier sheet into at least one pad of note sheets.

In other, more detailed features of the invention, the method also includes adhering at least two pads to one another with adhesive tape.

In other, more detailed features of the invention, the method also includes adhering at least two pads to a backing card. Also, the two pads can be glued to the backing card.

In other, more detailed features of the invention, the method also includes perforating the film.

In other, more detailed features of the invention, the method also includes adhering at least one pad to an adhesive tape or backing card.

In other, more detailed features of the invention, the method also includes coating a topcoat onto the first side of the film. Also, a primer or a release material can be coated onto the first side of the film. Also, a primer can be coated onto the second side of the film.

In other, more detailed features of the invention, the method also includes laminating the overlay to the first side of the film with adhesive.

Numerous advantages and benefits of the inventive subject matter disclosed herein will become apparent to those of ordinary skill in the art upon reading and understanding the present specification.

### BRIEF DESCRIPTION OF THE DRAWING(S)

The inventive subject matter disclosed herein can take form in various components and arrangements of components, and in various steps and arrangements of steps. The drawings are only for purposes of illustrating exemplary embodiments and are not to be construed as limiting. Further, it is to be appreciated that the drawings may not be to scale.

FIG. 1 is a top plan view of one exemplary embodiment of a note sheet embodying aspects of the present inventive subject matter, including a body portion and generally rounded tab portion.

FIG. 2 is a top plan view of another exemplary embodiment of a note sheet embodying aspects of the present inventive subject matter, wherein the tab portion is generally rectangular.

FIG. 3 is a top plan view of yet another exemplary embodiment of a note sheet embodying aspects of the present inventive subject matter, wherein the tab portion is again generally rectangular.

FIG. 4 is a top plan view of another exemplary embodiment of a note sheet embodying aspects of the present inventive subject matter, wherein the body portion includes a plurality of selectively separable sub-portions.

FIG. 5 is a top plan view of yet another exemplary embodiment of a note sheet embodying aspects of the present inventive subject matter, further including notches along the edges of the body portion which are co-located with the ends of lines of weakness defining the sub-portions of the body portion.

FIG. 6 is cross section view taken along section line A-A of FIG. 1, showing one exemplary embodiment of a multi-layer construction of the note sheet.

FIG. 7 is cross section view taken along section line A-A of FIG. 1, showing another exemplary embodiment of the multi-layer construction of the note sheet.

FIG. 8 is cross section view taken along section line B-B of FIG. 4, showing an exemplary embodiment of a multi-layer construction of the note sheet.

FIG. 9 is a diagrammatic illustration showing an exemplary use of the note sheet illustrated in FIG. 1.

FIG. 10 is a diagrammatic illustration showing an exemplary use of the note sheet illustrated in FIG. 4.

FIG. 11 is a top perspective view showing an exemplary pad of note sheets including a plurality of the note sheets from FIG. 2 stacked one on top of the other.

FIG. 12 is a side elevational view showing the exemplary pad illustrated in FIG. 11.

FIG. 13 is a top perspective view showing one exemplary embodiment of a multi-pad configuration in accordance with aspects of the present inventive subject matter, the multi-pad configuration including a plurality of the pads illustrated in FIG. 11.

FIG. 14 is a bottom perspective view of the multi-pad configuration illustrated in FIG. 13.

FIG. 15 is a top perspective view showing another exemplary embodiment of a multi-pad configuration in accordance with aspects of the present inventive subject matter, the multi-pad configuration including a plurality of the pads illustrated in FIG. 11.

FIG. 16 is a top perspective view showing an exemplary pad of note sheets including a plurality of the note sheets from FIG. 4 stacked one on top of the other.

FIGS. 17a and 17b are diagrammatic illustrations showing how a prior art note sheet can become undesirably detached from an underlying page when the note sheet is used to lift or turn the page.

FIGS. 18a and 18b are diagrammatic illustrations show how a note sheet in accordance with aspect of the present inventive subject matter remains adhered to an underlying page when the note sheet is used to lift or turn the page.

FIG. 19 is a diagrammatic illustration showing how a note sheet in accordance with aspects of the present inventive subject matter is used to lift or turn a page.

FIG. 20 is a flowchart of a method of manufacturing an exemplary multi-pad configuration in accordance with aspects of the present inventive subject matter.

FIG. 21 is a top plan view of another exemplary embodiment of a note sheet having a rectangular body portion and two rounded tab portions, with one of the rounded tab portions including an overlay.

FIG. 22 is a top perspective view of a pad of aligned note sheets including the note sheet of FIG. 21 and a bottom carrier sheet.

FIG. 23 is a top perspective view of a pad of alternating note sheets including the note sheet of FIG. 21 and a bottom pad carrier sheet, where the overlay of the next-to-the-top note sheet is visible through the top note sheet.

FIG. 24 is a top perspective view of eight stacked pads of note sheets wherein the pads of note sheets are coupled to a perforated backing card that contacts the bottom surface of each pad of note sheets.

FIG. 25 is a bottom perspective view of the eight stacked pads of note sheets of FIG. 24.

FIG. 26 is a top perspective view of eight stacked pads of note sheets wherein the pads of note sheets are coupled to a slit backing card, the two pieces of which are held together with a piece of tape, and the backing card contacts the bottom surface of each pad of note sheets.

FIG. 27 is a bottom perspective view of the eight stacked pads of note sheets of FIG. 26.

FIG. 28 is a top perspective view of another note sheet having a top surface with lines, a rectangular body portion, and a rectangular tab portion with rounded shoulders and an overlay

### DETAILED DESCRIPTION OF THE EMBODIMENT(S)

For clarity and simplicity, the present specification shall refer to structural and/or functional elements, relevant standards and/or protocols, and other components that are commonly known in the art without further detailed explanation as to their configuration or operation except to the extent they have been modified or altered in accordance with and/or to accommodate the preferred embodiment(s) presented herein.

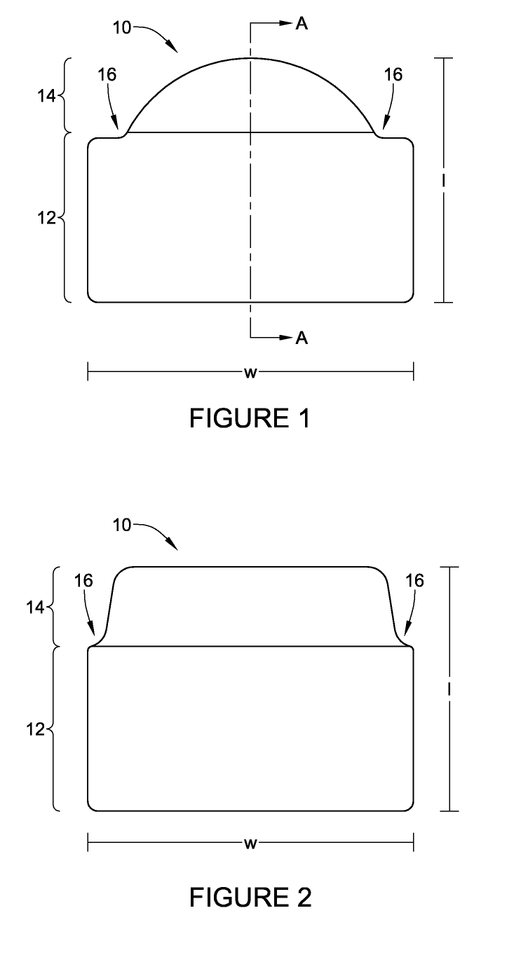

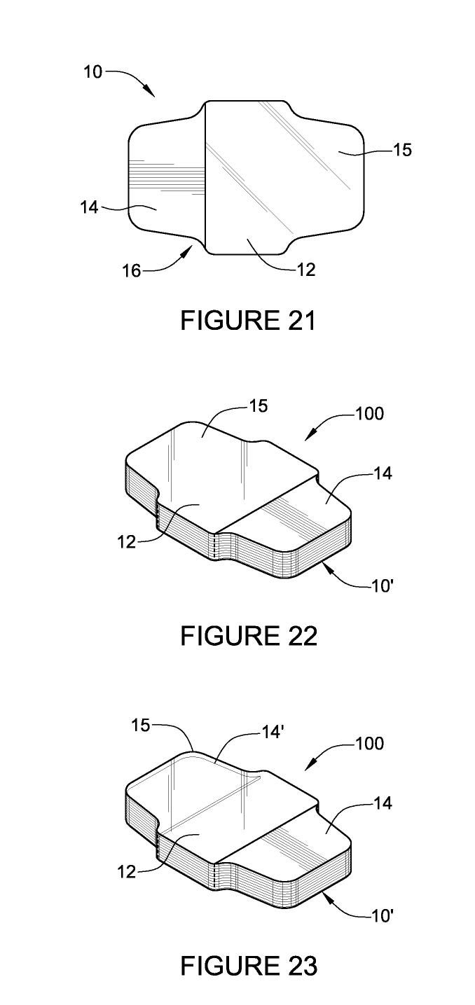

With reference now to FIGS. 1-5 and 21, there are shown note sheets 10 according to various exemplary embodiments of the present inventive subject matter. In each case, the note sheet 10 includes a generally rectangular body portion 12 and a tab portion 14 extending from one edge of the body 12. As illustrated, the body and tab portions 12 and 14 are joined to one another or otherwise integrally formed with a pair of arced or curved shoulders 16 therebetween. Suitably, the arced or curved shoulders 16 have a radius of curvature greater than about 1/16 inch. In one embodiment, the radius of curvature is between about 1/16 inch and about ¼ inch. In yet another embodiment, the radius of curvature is about ⅛ inch. As shown in FIG. 21, a second tab portion 15 can be included extending from a second edge of the body portion 12.

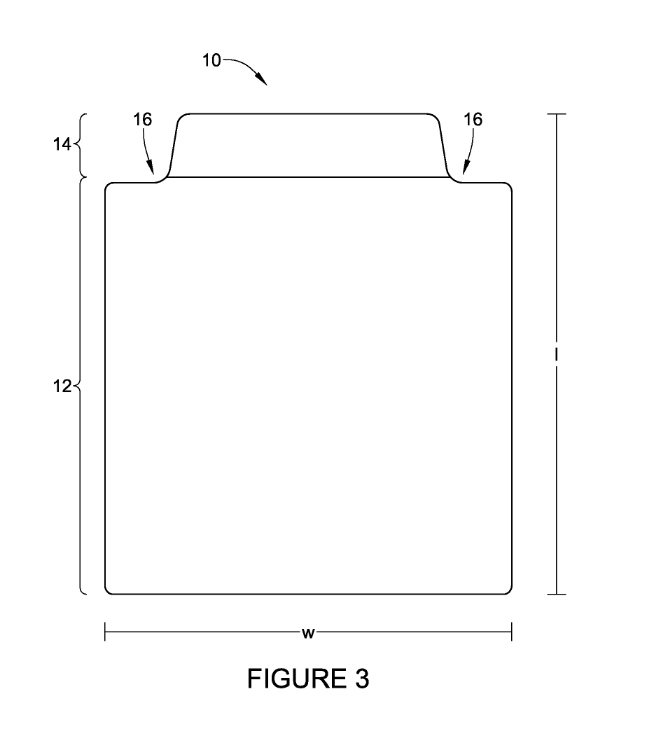

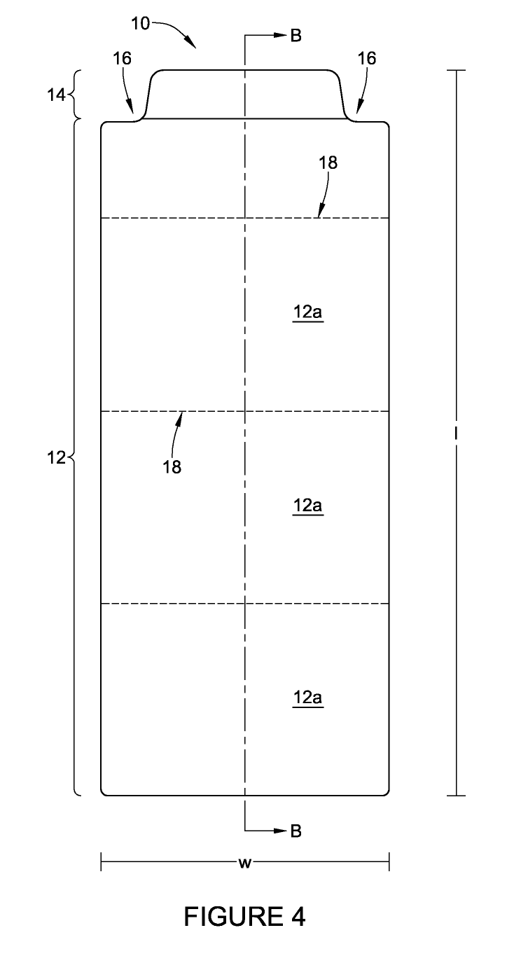

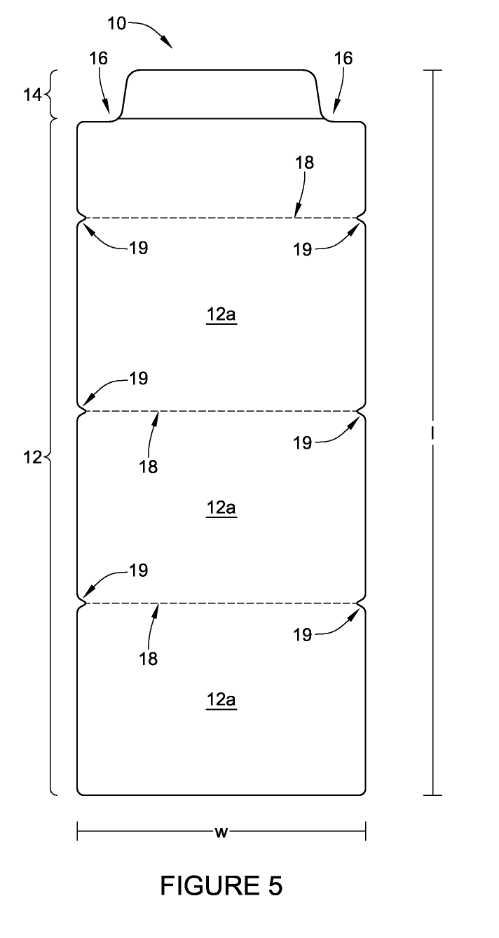

Suitably, the note sheet 10 has as overall length ‘l’ and an overall width ‘w’. For example, where the dimensions are given in the format l×w and the values are approximate: as illustrated in FIG. 1, the note sheet 10 is suitably 1.5 inches×2 inches with a generally rounded tab portion 14; as illustrated in FIG. 2, the note sheet 10 is suitably 1.5 inches×2 inches with a generally rectangular tab portion 14; as illustrated in FIG. 3, the note sheet is suitably 3.5 inches×3 inches again with a generally rectangular tab portion 14; and, as illustrated in FIGS. 4 and 5, the note sheet 10 is suitably 7.5 inches×3 inches with a body portion 12 that includes a plurality of selectively separable sub-portions 12a. In one embodiment, for example, sub-portions 12a are 2 inches×3 inches. Of course, it is to be appreciated, that other suitable dimensions, tab shapes, etc. can also be employed for various embodiments of the note sheet 10.

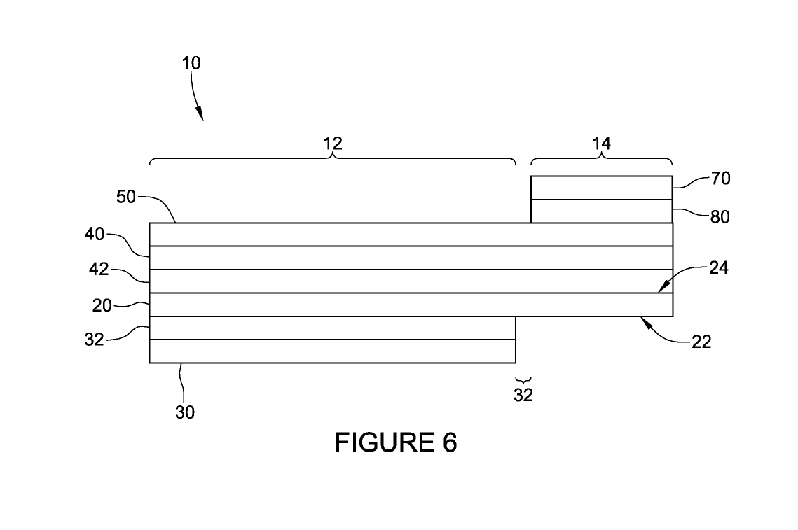

FIG. 6 shows an exemplary cross section of the note sheet 10. As shown, the cross section is taken through the embodiment shown in FIG. 1, however, it is to be appreciated that the same or similar cross section is also applicable to FIGS. 2 and 3. As shown, the note sheet 10 is suitably a coated, multi-layer, and/or laminate construction including a base layer or film 20, e.g., such polyethylene terephthalate (PET). Optionally, the base layer or film 20 can also be polyethylenes, polypropylenes, other polyolefins, polystyrenes, polyesters, polycarbonates, vinyl acetates, other acetates, cellulosics, acrylics, and mixtures or laminates thereof. Any polymer capable of forming translucent or transparent films is suitable. In one embodiment, the film is from approximately 4 mils to approximately 6 mils thick. In an alternative embodiment, the film is less than 4 mils in thickness. In yet another alternative embodiment, the film is greater than 4 mils in thickness. On a first major surface or backside 22 of the film 20 a removable or repositionable adhesive layer 30 is provided. The adhesive 30 is, for example, a pressure sensitive adhesive (PSA). Suitable adhesives include repositionable adhesives disclosed in U.S. Pat. Nos. 4,810,763 to Mallya, et al.; 4,944,888 to Mallya, et al.; and 5,656,705 to Mallya, et al., all of which are incorporated by reference herein in their entirety. The adhesive layer is from approximately 0.3 mil to approximately 0.8 mil thick in one embodiment. Specific examples of adhesive 30 include, but are not limited to, for example, UR2 (Avery Dennison Corporation of Pasadena, Calif.), MICRONAX 240-00 (Franklin International of Columbus, Ohio), or GEL-TAC (Paper Conversions, Inc. (PCI) of Syracuse, N.Y.), COVINAX 210-00 (Franklin International of Columbus, Ohio) or R-423 (Avery Dennison Corporation of Pasadena, Calif.). Optionally, a primer 32 is interposed between the backside 22 of the film 20 and the adhesive 30 to enhance the anchorage of the adhesive 30 to the film 20. When used, primers are less than approximately 0.5 mil in thickness. Suitable primers for the primer 32 can be prepared by using, for example, a pigment and a binder. Suitable pigments include, for example, magnesium hydroxide, magnesium carbonate, magnesium sulfate, calcium oxide, calcium hydroxide, calcium carbonate, satin white, calcium silicate, zinc oxide, titanium oxide, aluminum oxide, aluminum hydroxide, talc, or kaolin. Suitable binders include materials such as, for example, starch, polyvinyl alcohol, carboxymethylcellulose, styrene-butadiene copolymer, an acrylic copolymer, or a vinyl acetate copolymer. For example, suitable primers are disclosed in U.S. Pat. No. 5,670,226 to Yoshizawa, et al., which is incorporated by reference herein in its entirety. Of course, any number of known primers can be used as desired.

In the illustrated embodiment, the adhesive 30 covers all or most of the backside 22 of the body portion 12 of the note sheet 10, but does not reside on the backside 22 of the tab portion 14 of the note sheet 10. As can be appreciated, the substantially complete coverage of the backside 22 of the body portion 12 of the note sheet 10 with adhesive 30 promotes better adhesion when the note sheet 10 is adhered to a document page or other object. Alternatively, the adhesive 30 can be pattern coated or otherwise cover less than the entire backside 22 of the body portion 12 of the note sheet 10. Suitably, pattern-coated adhesives will extend substantially along all edges of the body portion of the note sheet, thereby adhering the edges firmly to a document page or other object.

On a second major surface or front side 24 of the film 20 (i.e., opposite the first major surface or backside 22), an ink receptive or other suitable topcoat 40 can be provided. For example, suitable ink receptive topcoats for the topcoat 40 are disclosed in U.S. Pat. No. 6,265,043 to Vinyard, et al., which is incorporated by reference herein in its entirety. Of course, other known ink receptive top coats can also be employed. Optionally, a printable release coating 50 can be employed as a topcoat. The topcoat is optional, however, in embodiments that include a topcoat, the topcoat is approximately 0.5 mil to approximately 1.0 mil in thickness. Optionally, a primer 42 is interposed between the front side 24 of the film 20 and the topcoat 40 to enhance the anchorage of the topcoat 40 to the film 20. Suitable primers for the primer 42 include, e.g., the same primers and the same thickness as listed above for primer 32.

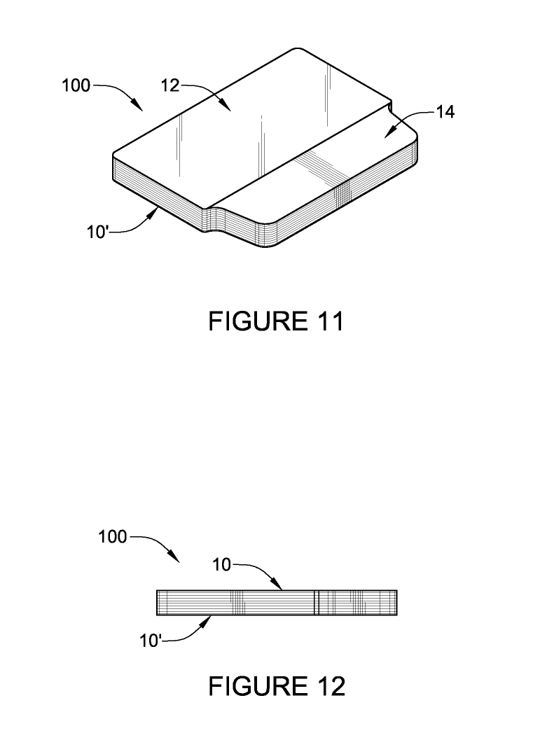

With additional reference now to FIG. 11, it is to be appreciated that optionally a plurality of note sheets 10 as described herein can be provided in the form of a pad 100, i.e., with the plurality of note sheets 10 being stacked one on top of the other such that each overlying note sheet 10 is removably and/or releasably adhered to a front side of its underlying counterpart via the adhesive layer 30 on the backside 22 of the respective note sheet 10. Accordingly, depending on the aggressiveness of the adhesive 30 that is used on the backsides 22 of the note sheets 10, optionally, an additional release coating or layer 50 (see FIGS. 6-8) is formed over the topcoat 40 of each note sheet 10 to promote the desired release of the adhesive 30 therefrom. In one embodiment, a Suitable release coating for the release layer 50 includes SECOAT 163 (Omnova Solutions, Inc. of Fairlawn, Ohio) and RA-120W (Mayzo, Inc. of Norcross, Ga.), for example. Layers of release coatings can be from approximately 0.2 mil to approximately 0.5 mil. Examples of suitable release coatings include release coatings that can be printed upon. Suitable release coatings 50 include, for example, the release systems as disclosed in U.S. Pat. No. 6,074,747 to Scholz, et al., U.S. Pat. No. 7,309,731 to Shih, et al. and WO 2000/052080 to Hseih, et al., all of which are incorporated by reference herein in their entirety.

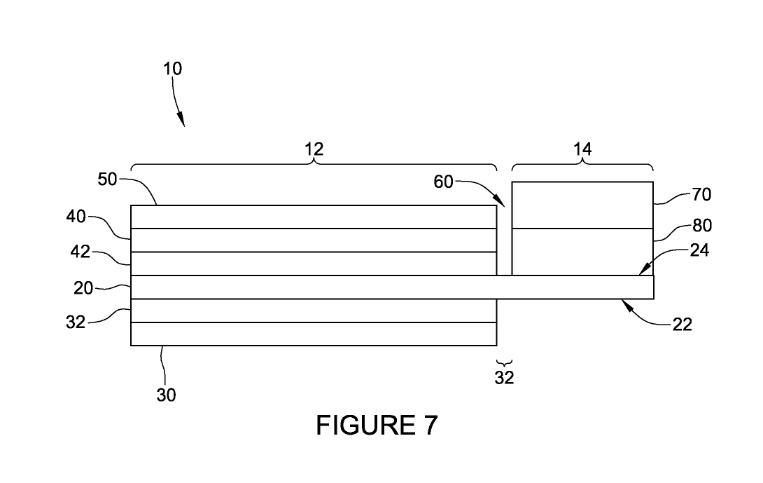

As shown in FIG. 6, the ink receptive topcoat 40, the optional primer 42 therefor and the optional release coat 50 cover all or most of the front side 24 of the note sheet 10, i.e., including both the body and tab portions 12 and 14. Alternatively, however, as shown in FIG. 7, the ink receptive topcoat 40, the optional primer 42 therefor and the optional release coat 50 can only cover all or most of the body portion 12 of the front side 24 of the note sheet 10, and not reside on the front side 24 of the tab portion 14 of the note sheet 10. In the latter case, a gap 60 of up to approximately 0.2 inch can exist between where these components end and the tab portion 14 of the note sheet 10 begins. Alternatively, the gap can be absent.

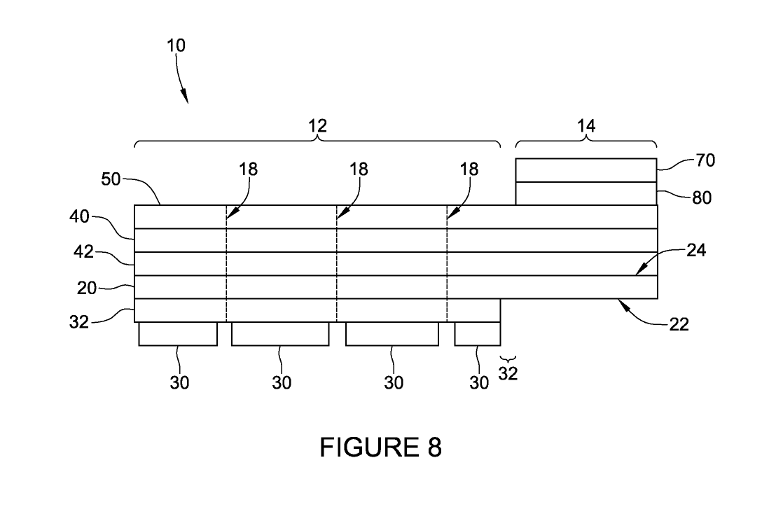

In either case, an overlay 70 is suitably adhered to the front side 24 of the tab portion 14 of the note sheet 10, e.g., via a suitably aggressive adhesive 80. Suitably, the overlay 70 is paper or another material suitable for receiving ink and/or otherwise writing on and is from approximately 3 mils to approximately 4 mils in thickness. The adhesive 80 is, for example, a suitably aggressive pressure sensitive adhesive (PSA), or alternatively, the overlay can be adhered with traditional hot melt adhesives, gums, or other permanent adhesives, or the overlay can be welded onto or pressed into the partially molten base layer 20. Suitably, the adhesive 80 is a permanent adhesive such that the overlay 70 is not readily removable from the note sheet 10 and the adhesive is from approximately 0.5 mil to 1.0 mil in thickness. In particular, with reference to the embodiment shown in FIGS. 6 and 8, the adhesive 80 is preferably significantly aggressive so as to overcome the effectiveness of the underlying release coat 50 and remain permanently adhered and/or tightly bonded to the tab portion 14 of the note sheet 10.

With reference now to FIGS. 4, 5 and 8, there are shown alternative embodiments of the note sheet 10 in which the body portion 12 thereof includes a plurality of distinct sub-sections or sub-portions 12a defined by a plurality of lines of weakness 18. For the sake of clarity and simplicity, elements that are the same as or similar to those described above in connection with prior embodiments are identified by like reference numerals in connection with the presently described embodiments. With regard to 12a, the sub-portions can be sized differently, i.e., a note sheet can have multiple sub-portions, each with different dimensions.

In one embodiment, the lines of weakness 18 are formed by perforated lines extending the width ‘w’ of the note sheet 10. The perforated lines are suitably made up of a plurality of discontinuous cuts or breaks extending completely through the entire thickness of the note sheet 10, with intermittent lands of uncut or intact areas being arranged between adjacent cuts or breaks. Alternatively, the lines of weakness 18 can be formed by scoring or partial die or other like cutting which does not extend entirely through the thickness of the note sheet 10. In any event, suitably, the lines of weakness 18 provide sufficient strength to prevent inadvertent, unwanted or unintentional separation or folding along the line 18 under normal use and/or wear, while still facilitating easy separation along the line 18 when folding, tearing or other like forces are intentionally applied. For example, where the base layer 20 is a 5 mils thick polyester film and the lines of weakness 18 are implemented as per the previously described perforations, the perforated line is suitably formed by cuts or breaks that measure about 0.12 inch in length with interposed lands that measure about 0.02 inch in length. In another embodiment, the cuts measure about 0.06 inch and the lands measure about 0.03 inch. In yet another embodiment, the cuts measure about 0.08 inch and the lands measure about 0.04 inch. Other lengths of cuts and lands can be used.

In suitable embodiments, each perforated line forming a line of weakness 18 begins and ends at the edges of the note sheet 10 with a land. Perforations with land elements at each end thereof will promote resistance to tearing along the line of weakness 18, unless and/or until a purposeful tearing or other like separating force is applied. Optionally, as shown in FIG. 5, notches 19 in the edge of the note sheet 10 are co-located with each end of the lines of weakness 18. The notches 19 aid in identifying for the user the locations of the lines of weakness 18 and assist in directing and easing separation along the lines of weakness 18 when appropriate tearing or other suitable forces are applied.

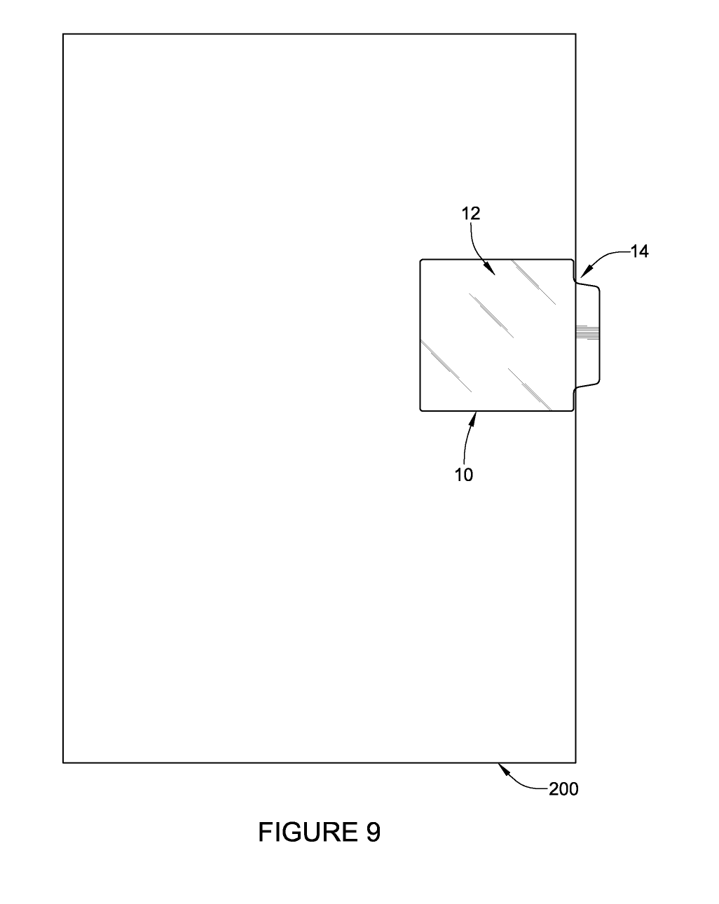

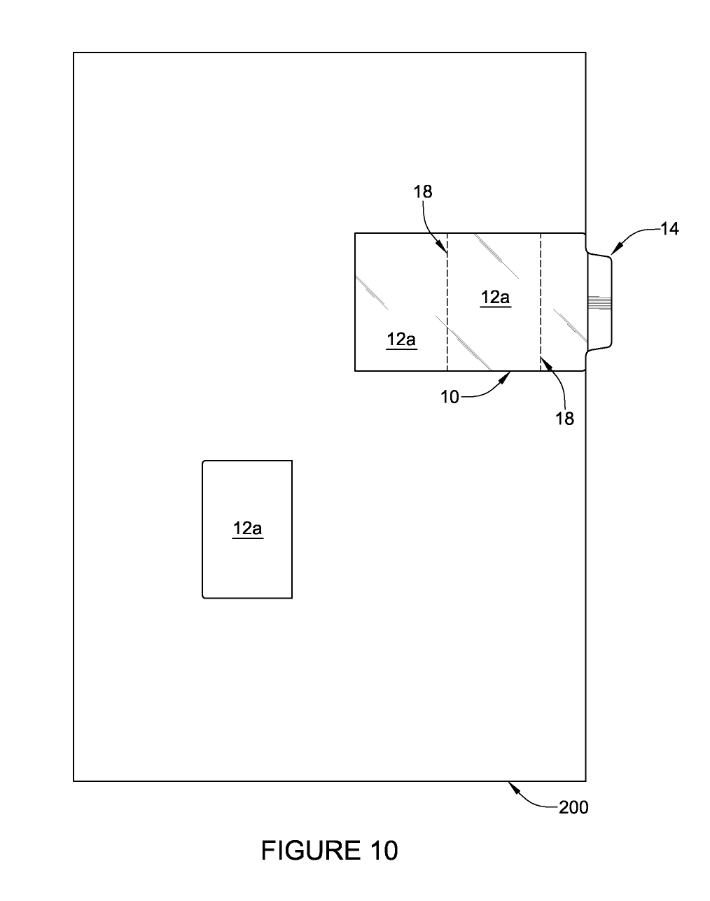

With reference now to FIGS. 9 and 10, an exemplary use of the note sheet 10 is illustrated. In general, individual note sheets 10 can be selectively removed from pads 100 thereof (see, e.g., FIGS. 11-16) and adhered to desired objects, e.g., via the exposed adhesive 30 on the backside 22 of the base layer or film 20. Optionally, a user can write on or mark the tab portion 14 or the body portion 12 as desired with a standard writing implement, e.g., either before or after removing the note sheet 10 from the pad 100 or before or after sticking the note sheet 10 to the desired object.

More specifically, as shown in FIGS. 9 and 10, the note sheet 10 is adhered to a document page 200, e.g., with the tab portion 14 extending beyond an edge of the page 200 thereby marking or identifying the same, e.g., even when the document page 200 is placed in a stack of such document pages. Additionally, as shown in FIG. 10, it is to be appreciated that the lines of weakness 18 permit one or more sub-portions 12a of the body portion 12 of the note sheet 10 to be selectively separated from the remainder of the note sheet 10, e.g., so that the separated sub-portions 12a can be selectively adhered to a desired area of a document page 200 or elsewhere remote from the remainder of the note sheet 10.

Suitably, the overlay 70 on the tab portion 14 provides good ink reception and/or writability so that a user can mark the same as desired with a standard writing implement, e.g., pencil, ballpoint pen, rollerball, gel pen, highlighter, marker, etc. Additionally, the tab overlay 70 is optionally provided in an aesthetically pleasing and/or eye catching color, such as, for example, blue, green, red, pink, yellow, cyan, magenta, purple, white, or taupe, or pastel or neon variants of these, to promote its ready identification and/or to stand out from or contrast with the document page 200.

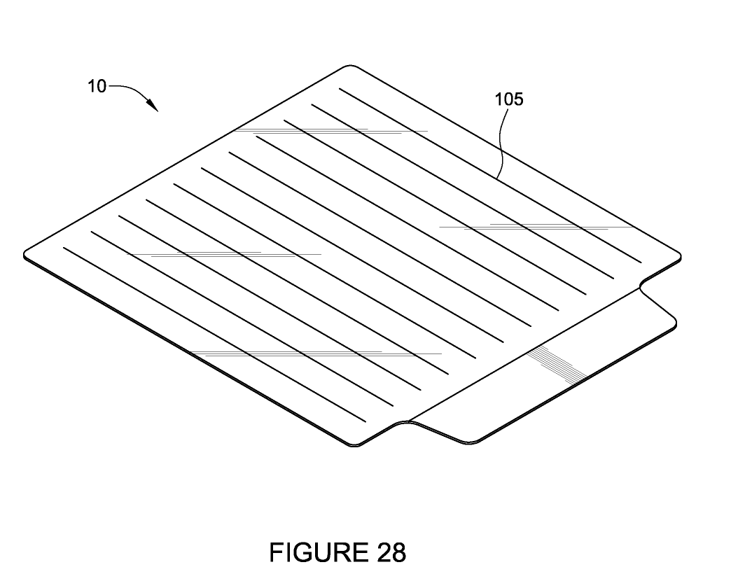

Suitably, the topcoat 40 also provides good ink reception and/or writability so that a user can mark the same as desired with a standard writing instrument, e.g., pencil, ballpoint pen, rollerball, gel pen, highlighter, marker, etc. In one suitable embodiment, the optionally provided release coat or layer 50 is selected and/or arranged so as to not significantly degrade or interfere with the ink reception and/or writability of the topcoat 40. Alternatively, the release coat or layer can itself be receptive to accepting indicia from a standard writing instrument. Indicia means any marking from a writing or printing instrument, including, but not limited to, pens, pencils, markers, highlighters, typewriters, label printers, desktop or personal printers, and copiers. Suitably, the body potion 12 of the note sheet 10 (e.g., including any applied release coat 50, the topcoat 40, the underlying base layer or film 20, etc.) is translucent so that document page 200 can be viewed therethrough, i.e., so that any writing or other like markings on the document page 200 can still be viewed even when the body portion 12 of the note sheet 10 is covering the same. Optionally, the film 20 can be lightly tinted with a desired color (e.g., that contrasts with the document page 200), such as for example, clear, gray, blue, green, yellow, or pink, to provide a more pleasing look, to aid in highlighting and to clearly demark the edges of the body portion 12, e.g., so that a user can avoid, if they so desire, writing off the edge of the note sheet 10 and onto the document page 200. Additionally, as shown in FIG. 28, indicia 205 can be preprinted onto the note sheet, for example, lines can be printed onto the note sheet, to aid in aligning additional indicia.

Notably, the arced and/or curved shoulders 16, as well as the radiused or rounded corners of the note sheet 10, give the note sheet 10 a professional, more finished and/or distinct appearance. Additionally, the tab portion 10 extending beyond the edge of the document page 200 provides a user ready access thereto, even if the page 200 is located under a stack of one or more other similar document pages. Accordingly, the tab portion 10 can be selectively grasped by a user to locate, lift, and/or turn the page 200. Notably, in this case, the radiused or curved shoulders 16 help prevent unwanted separation or detachment of the note sheet 10 from the page 200 by directing applied peel force (e.g., resulting from lifting or otherwise manipulating the page 200 via the attached note sheet 10) away from the corners of the note sheet 100 where separation would usually occur. Additionally, the radiused or rounded corners of the note sheet 10 eliminate sharp corners that could poke or otherwise irritate users.

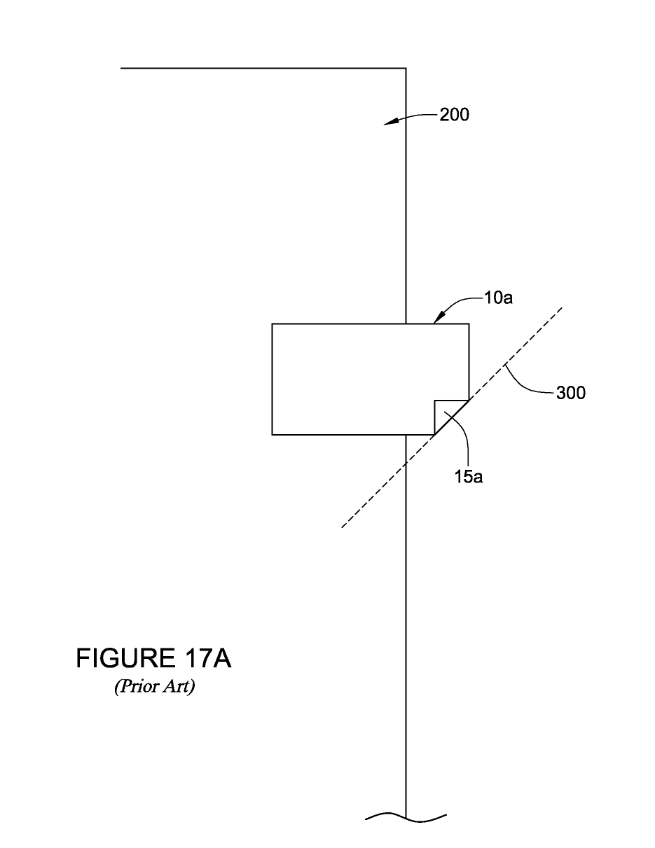

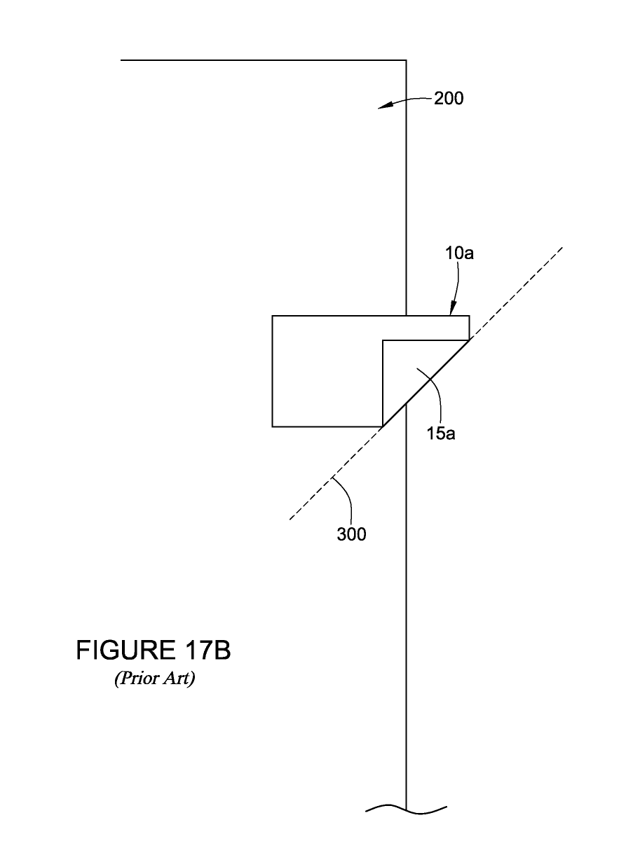

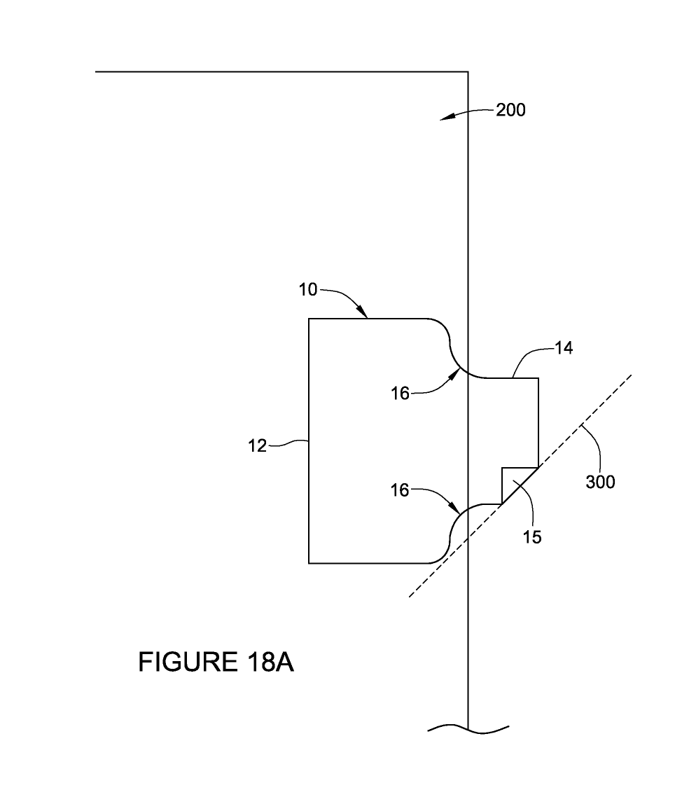

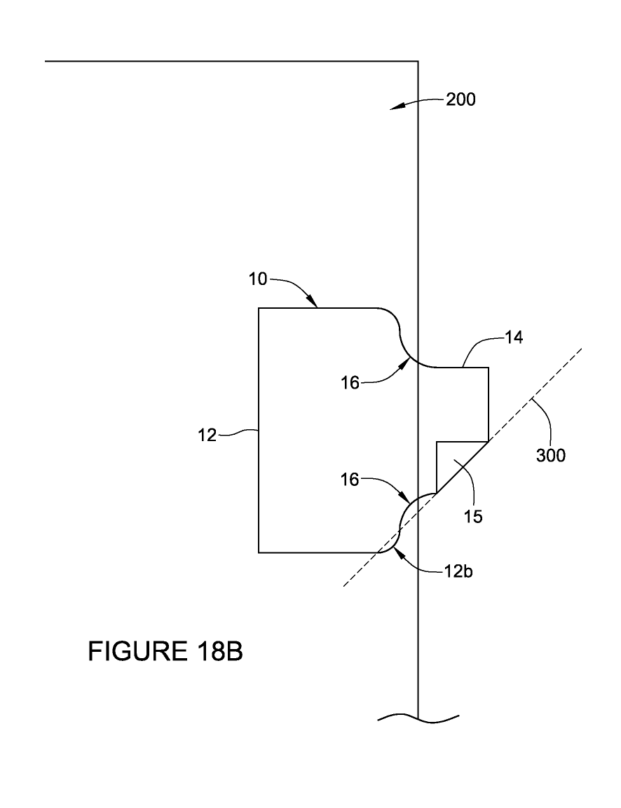

As already mentioned above, the shoulders 16 aid in maintaining adherence and/or attachment of the note sheet 10 to a document page 200 when the note sheet 10 is used to lift the document page, rather than peeling from the document page 200. For example, compare how a traditional note sheet 10a without shoulders 16 functions under such manipulation (as shown in FIGS. 17a and 17b) with the function of a note sheet 10 having shoulders 16 in accordance with aspects of the present inventive subject matter (as shown in FIGS. 18a and 18b).

With reference to FIG. 17a, a user can grasp the corner 15a of the note sheet 10a to lift or turn the page 200 to which the note sheet 10a is adhered. As shown, the corner 15a will turn-up or bend creating a peel front or bending front 300. Upon further lifting of the corner 15a, the front 300 advances obliquely towards the edge of the page 200. Notably, when progressing from the state illustrated in FIG. 17a to the state illustrated in FIG. 17b, at no point in time does any portion of the note sheet 10a remain behind the peel front 300. That is to say, there is no portion of the note sheet 10a which remains behind the advancing front 300 to resist peeling from the page 200.

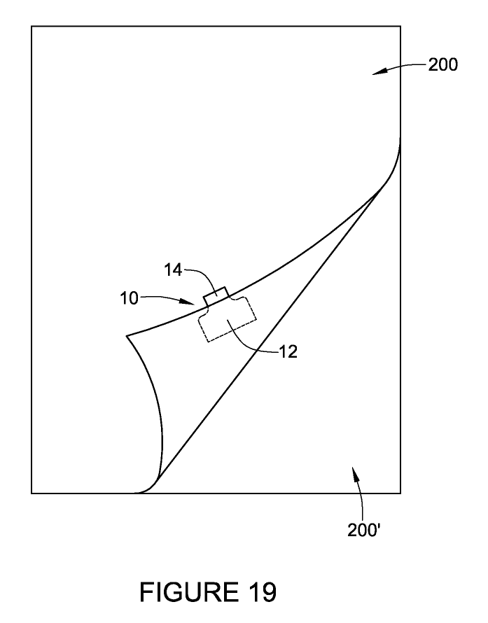

In contrast, with reference now to FIG. 18a, a user can again grip the corner 15 on the tab portion 14 of the note sheet 10 to lift or turn the page 200 to which the note sheet 10 is adhered via the body portion 12 of the note sheet 10. Again, as shown, the corner 15 will turn-up or bend creating the peel front or bending front 300. Again, upon further lifting of the corner 15, the front 300 advances obliquely towards the edge of the page 200. This time however, when progressing from the state illustrated in FIG. 18a to the state illustrated in FIG. 18b, a part (namely area 12b) of the body portion 12 of the note sheet 10 remains behind the advancing peel front 300 to thereby resist peeling of the note sheet 10 from the page 200. Accordingly, as shown in FIG. 19, the sheet 200 is turned and/or otherwise lifted, e.g., to reveal an underlying sheet 200′.

Additionally, it is to be appreciated that in embodiments where the adhesive 30 covers all or nearly all of the body portion 12 of the backside 22 of the film 20, a wider adhesion area can be had with respect to the page 200. Accordingly, as compared to conventional adhesive backed note sheets that have only partial adhesive coverage on their backsides, the strength of the adhesive 30 can be reduced while still achieving the same degree of overall adhesion with respect to the page 200. Therefore, when the note sheet 10 is selectively removed from the page 200, the likelihood of damaging the page 200 or lifting print therefrom is reduced due to the relatively less aggressive adhesive 30.

Referring again to FIGS. 7-8, optionally, a small gap 32 is provided between end of the adhesive 30 and the beginning of the tab portion 14 of the note sheet 10. The gap 32 provides the user some leeway in securing the note sheet 10 at the edge of the page 200 so that the tab portion 14 extends past the edge of the page 200 without any adhesive 30 being exposed. Additionally, a similar gap or absence of adhesive 30 can optionally be located around the periphery of the body portion 12 of the note sheet 10 and/or proximate to the lines of weakness 18 (see, e.g., FIG. 8). This aids in allowing the user to selectively lift and/or remove the body portion 12 or sub-sections 12a thereof from the page 200 after they have already been adhered thereto. In this way, the note sheet 10 or selected portions 12a thereof can be repositioned as desired.

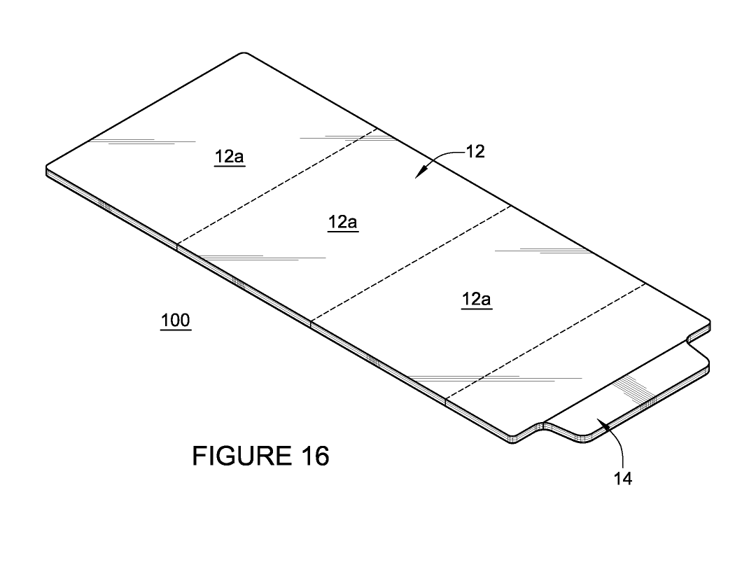

As previously mentioned, suitably a plurality of note sheets 10 are arranged in a pad 100. FIGS. 11 and 12 illustrate one such exemplary pad 100 including note sheets 10 such as the one illustrated in FIG. 2. However, it is to be appreciated that the pad 100 can likewise include note sheets 10 according to any of the embodiments described or contemplated herein. For example, FIG. 16 illustrates an exemplary pad 100 including a plurality of note sheets 10 such as the one illustrated in FIG. 4. Another exemplary pad 100 is shown in FIG. 22 of note sheets 10 such as the one illustrated in FIG. 21. In FIG. 22, tab portion 14 includes an overlay and is aligned with tab portion 14 on the underlying note sheet. Yet another exemplary pad 100 is shown in FIG. 23 of note sheets 10 such as the one illustrated in FIG. 21. FIG. 23 differs from FIG. 22 in that tab portion 14 includes an overlay and is aligned with the second tab portion 15 of the underlying note sheet.

In addition to the note sheets 10, optionally the pad 100 includes a carrier sheet 10′ on the bottom side of the pad 100. As shown, the carrier sheet 10′ is similarly shaped to the sheets 10 stacked on top thereof. Suitably, the carrier sheet 10′ is formed from a release liner, e.g., such a siliconized or calendared paper or other known release liner material. Alternatively, the carrier sheet can be made from a backing card or other sufficiently rigid or stiff support structure having a layer of release material coated onto a surface of the card. Yet another alternative includes a release liner that is adhered to a backing card.

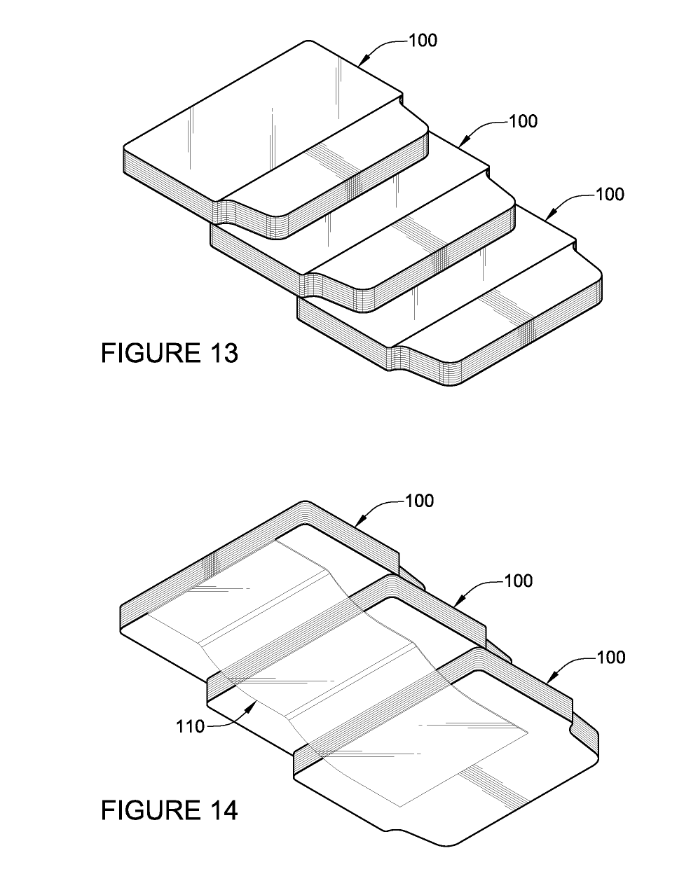

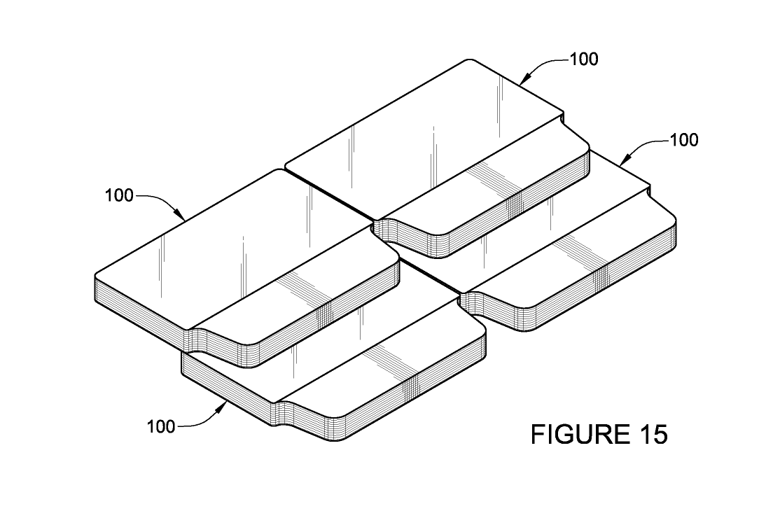

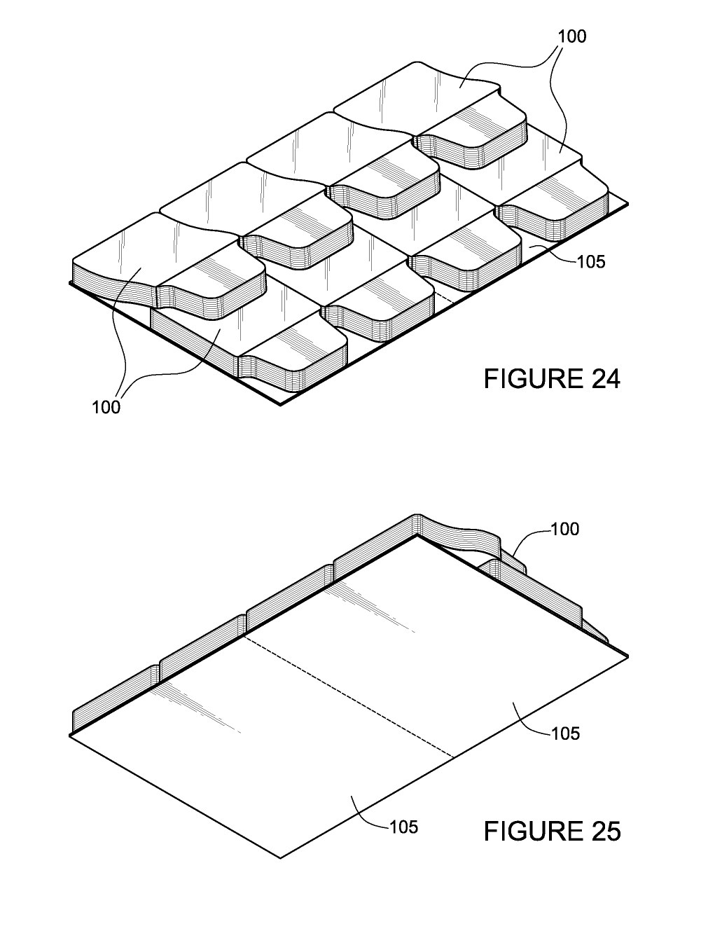

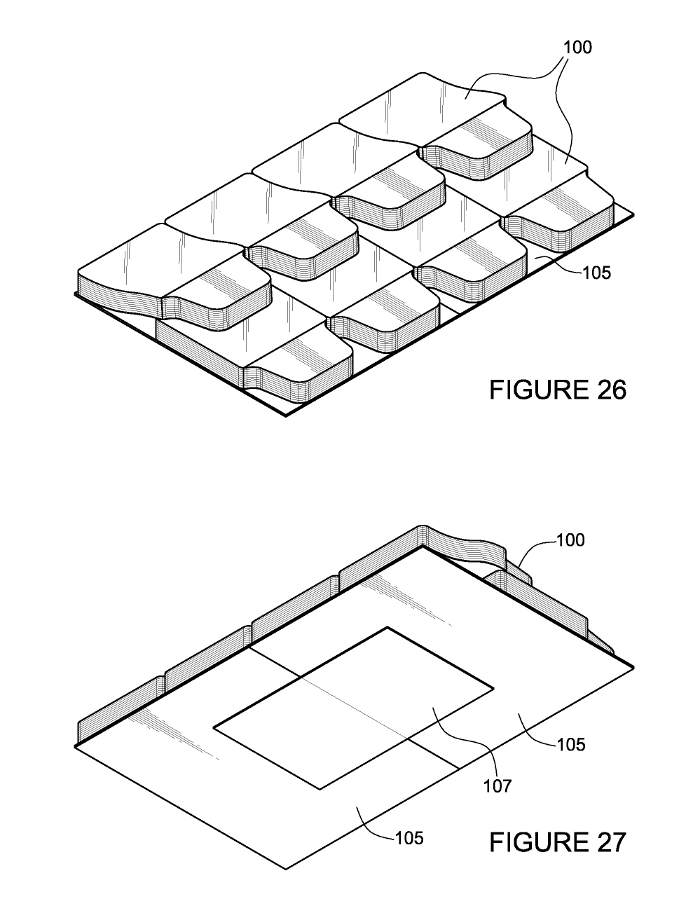

With reference now to FIGS. 13-15 and 24-27, multiple pads 100 can optionally be packaged together, e.g., in partially overlapping fashion (see, e.g., FIG. 13) and/or in a side-by-side arrangement (e.g., as shown in FIG. 15). Suitably, as shown in FIG. 14, the pads 100 can be held together on the backsides thereof by an adhesive tape 110 or the like. Furthermore, the pads 100 can be adhered to a backing card 105 as shown, for example, in FIGS. 24-27. Additionally, the backing card can include a weakened separation line 107, for example, a perforation or a score, for separation of the backing card into two or more backing cards with one or more attached pads, as shown, for example in FIGS. 24 and 25. In an alternative embodiment, the backing card can be two backing cards that are taped together with adhesive tape 109, as shown, for example, in FIGS. 26 and 27. Optionally, each pad 100 includes note sheets 10 of the same color or tint and a given package can include pads 100 of one or more colors or tints.

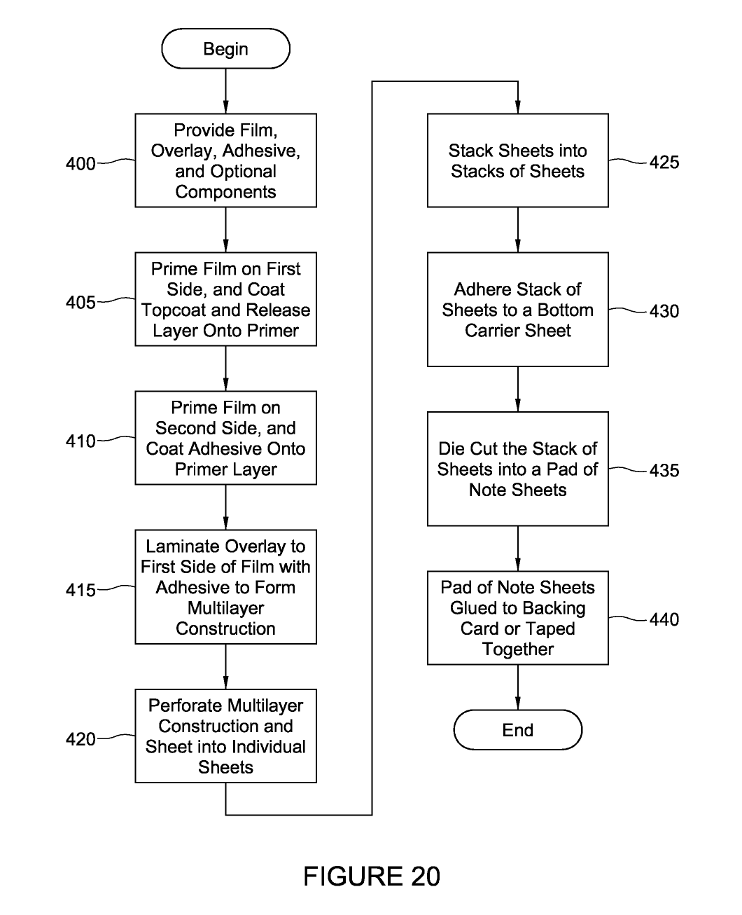

An exemplary method of manufacture, as shown in FIG. 20, includes providing a film, an overlay, an adhesive, and optional components such as a topcoat, release material, and primers in step 400. In step 405, the film is coated on a first side with a primer, if needed, followed by coating the topcoat, and followed by the release material, if needed. In step 410, the film is coated on a second side with a primer, if needed, followed by coating the adhesive. The overlay is laminated with adhesive to the first side of the film to form the multilayer construction in step 415, and the multilayer construction is perforated, if needed, and sheeted in step 420. The individual sheets are stacked upon one another to form a stack of sheets in step 425. The stack of sheets is adhered to a carrier sheet in step 430 and die cut into pads in step 435. The carrier sheet on the pad is glued to a backing card, or alternatively, pads are taped together in step 440.

In any event, it is to be appreciated that in connection with the particular exemplary embodiment(s) presented herein certain structural and/or functional features are described as being incorporated in defined elements and/or components. However, it is contemplated that these features can, to the same or similar benefit, also likewise be incorporated in other elements and/or components where appropriate. It is also to be appreciated that different aspects of the exemplary embodiments can be selectively employed as appropriate to achieve other alternative embodiments suited for desired applications, the other alternative embodiments thereby realizing the respective advantages of the aspects incorporated therein.

Additionally, it is to be appreciated that certain elements described herein as incorporated together can under suitable circumstances be stand-alone elements or otherwise divided. Similarly, a plurality of particular functions described as being carried out by one particular element can be carried out by a plurality of distinct elements acting independently to carry out individual functions, or certain individual functions can be split-up and carried out by a plurality of distinct elements acting in concert. Alternatively, some elements or components otherwise described and/or shown herein as distinct from one another can be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

What is claimed is:

1. A note sheet comprising:
a body portion; and
a tab portion integral with the body portion and extending from an end of the body portion;
wherein:
at a location where the tab portion and the body portion meet one another, at least one arced shoulder is formed therebetween; and
the note sheet is formed from a multilayer construction including:
a base layer which extends a substantial entirety of the body and tab portions of the note sheet, the base layer having a first surface and a second surface; and
a first layer of adhesive provided on the second surface of the base layer, the first layer of adhesive being located on the body portion of the note sheet, but not on the tab portion.

2. The note sheet of claim 1, wherein the multilayer construction further includes an overlay provided on the first surface of the base layer, the overlay being located on the tab portion of the note sheet, but not on the body portion.

3. The note sheet of claim 2, wherein the overlay is made of a paper material.

4. The note sheet of claim 2, wherein the multilayer construction further includes a second layer of adhesive disposed between the overlay and the base layer to secure the overlay to the base layer, the second layer of adhesive being located on the tab portion of the note sheet, but not on the body portion.

5. The note sheet of claim 4, wherein the multilayer construction further includes an ink receptive topcoat layer provided on the first surface of the base layer.

6. The note sheet of claim 5, wherein the multilayer construction further includes a release coat layer provided on the ink receptive topcoat layer opposite the base layer.

7. The note sheet of claim 5, wherein the release coat layer is receptive to marking with indicia.

8. The note sheet of claim 5, wherein the multilayer construction further includes a primer layer disposed on the first surface of the base layer between the ink receptive topcoat layer and the base layer, the primer layer aiding anchorage of the ink receptive topcoat layer to the base layer.

9. The note sheet of claim 8, wherein the primer layer, ink receptive topcoat layer, and release layer are provided on the body portion of the note sheet, but not on the tab portion.

10. The note sheet of claim 8, wherein the primer layer, ink receptive topcoat layer, and release layer are provided on the body portion of the note sheet and the tab portion, the primer layer, ink receptive topcoat layer, and release layer being disposed between the second layer of adhesive and the base layer on the tab portion of the note sheet.

11. The note sheet of claim 10, wherein the release layer and the second layer of adhesive are selected such that an interface therebetween does not functionally release the overlay from the note sheet.

12. The note sheet of claim 1, wherein the multilayer construction further includes a primer layer disposed on the second surface of the base layer between the first adhesive layer and the base layer, the primer layer aiding anchorage of the first adhesive layer to the base layer.

13. The note sheet of claim 1, wherein the base layer is a polyethylene terephthalate (PET) film.

14. The note sheet of claim 13, wherein the PET film is tinted with a color.

15. The note sheet of claim 1, wherein the first layer of adhesive covers substantially all of the body portion of the note sheet.

16. The note sheet of claim 1, wherein the first adhesive layer comprises a pressure sensitive adhesive (PSA).

17. The note sheet of claim 1, wherein the body portion of the note sheet is translucent.

18. The note sheet of claim 1, wherein the body portion includes at least one line of weakness extending across the body portion, the line of weakness dividing the body portion into distinct sub-sections such that at least one sub-section of the body portion is selectively removable from the note sheet by separating the sub-section from the body portion along the line of weakness.

19. The note sheet of claim 1, wherein the tab portion is a first tab portion, the end of the body portion is a first end, the body portion further includes a second end, and a second tab portion extending from the second end of the body portion.

20. A pad of note sheets comprising:
a plurality of note sheets stacked on top of one another;
each one of the plurality of note sheets including:
a body portion; and
a tab portion integral with the body portion and extending from an end of the body portion;
wherein:
at a location where the tab portion and the body portion meet one another, at least one arced shoulder is formed therebetween;
each one of the plurality of note sheets is formed from a multilayer construction including:
a base layer which extends a substantial entirety of the body and tab portions of each one of the plurality of note sheets, the base layer having a first surface and a second surface; and
a first layer of adhesive provided on the second surface of the base layer, the first layer of adhesive being located on the body portion of each one of the plurality of note sheets, but not on the tab portion; and
the plurality of note sheets is stacked such that an overlying note sheet is releasably adhered to an adjacent underlying note sheet via the first adhesive layer of the overlying note sheet.

21. The pad accordingly to claim 20, wherein the pad of note sheets includes a bottom-most note sheet, further comprising a release liner to which the bottom-most note sheet in the pad is releasably adhered via the first adhesive layer of the bottom-most note sheet, the release liner having an outer periphery that substantially matches an outer periphery of the note sheets.

22. The pad according to claim 20, wherein:
the tab portion is a first tab portion;
the end of the body portion is a first end;
the body portion further includes a second end;
a second tab portion extending from the second end of the body portion;
the first tab portion includes an overlay;
and plurality of note sheets are stacked such that the first tab portion of the overlying note sheet overlies the second tab portion of the adjacent underlying note sheet.

23. A package comprising:
at least two pads, each pad including:
a plurality of note sheets stacked on top of one another;
each one of the plurality of note sheets having a body portion and a tab portion integral with the body portion and extending from an end of the body portion;
wherein:
at a location where the tab portion and the body portion meet one another, at least one arced shoulder is formed therebetween;
each one of the plurality of note sheets is formed from a multilayer construction including:
a base layer which extends a substantial entirety of the body and tab portions of each one of the plurality of note sheets, the base layer having a first surface and a second surface; and
a first layer of adhesive provided on the second surface of the base layer, the first layer of adhesive being located on the body portion of each one of the plurality of note sheets, but not on the tab portion; and
the plurality of note sheets is stacked such that an overlying note sheet is releasably adhered to an adjacent underlying note sheet via the first adhesive layer of the overlying note sheet.

24. A package according to claim 23, wherein the at least two pads are joined together via an adhesive tape secured to the release liner of each pad in the package.

25. A package according to claim 23, wherein the at least two pads are adhered to a backing card.

26. A method for manufacturing a package of note sheets, the method comprising:
providing a film including a first side and a second side, an overlay, and an adhesive;
coating the second side of the film with the adhesive;
laminating the overlay to the first side of the film to form a multilayer construction;
sheeting the multilayer construction into sheets, each sheet having an adhesive layer side and an overlay-bearing side;
stacking the sheets to form a stack of sheets having the adhesive layer side of each sheet in contact with the overlay-bearing side of an adjacent sheet, a last sheet of the stack of sheets having an exposed adhesive layer side;
adhering the exposed adhesive layer side to a carrier sheet; and
die cutting the stack of sheets with adhered carrier sheet into at least one pad of note sheets.

27. The method of claim 26, further comprising adhering at least two pads to one another with adhesive tape.

28. The method of claim 26, further comprising adhering at least two pads to a backing card.

29. The method of claim 28 wherein the step of adhering at least two pads to a backing card includes gluing the at least two pads to the backing card.

30. The method of claim 26, further comprising perforating the film.

31. The method of claim 26, further comprising adhering the at least one pad of note sheets to an adhesive tape or backing card.

32. The method of claim 26, further comprising coating a topcoat onto the first side of the film.

33. The method of claim 32, wherein a primer is coated onto the first side of the film before coating the topcoat onto the first side of the film.

34. The method of claim 24, further comprising coating a release material onto the first side of the film.

35. The method of claim 26, wherein the step of laminating the overlay to the first side of the film includes laminating with adhesive.

36. The method of claim 26, where a primer is coated onto the second side of the film before coating the second side of the film with the adhesive.
